(19) United States
(12) Patent Application Publication
(10) Pub. No.: US 2016/0036370 A1
(43) Pub. Date: Feb. 4, 2016

(54) MOTOR DRIVING APPARATUS, MOTOR SYSTEM, AND CORRECTION CIRCUIT THEREOF

(71) Applicant: SAMSUNG ELECTRO-MECHANICS CO., LTD., Suwon-Si (KR)

(72) Inventor: Shin Jae KANG, Suwon-Si (KR)

(21) Appl. No.: 14/520,225

(22) Filed: Oct. 21, 2014

(30) Foreign Application Priority Data
Jul. 30, 2014 (KR) 10-2014-0097554

(51) Int. Cl. H02P 29/00

(52) U.S. Cl. CPC H02P 29/0044

(57) ABSTRACT

The motor driving apparatus according to an exemplary embodiment in the present disclosure may include: a controlling unit outputting a digital code; a converting unit converting the digital code into an analog driving signal; and a correction unit changing the analog driving signal at a predetermined ratio using a plurality of resistors.

### CROSS-REFERENCE TO RELATED APPLICATION

This application claims the benefit of Korean Patent Application No. 10-2014-0097554 filed on Jul. 30, 2014, with the Korean Intellectual Property Office, the disclosure of which is incorporated herein by reference.

### BACKGROUND

The present disclosure relates to a motor driving apparatus, a motor system, and a correction circuit thereof.

Motor controlling technology has been applied to various fields. In addition to a conventional motor controlling field, motor controlling technology has also been applied to other fields, such as that of mobile devices requiring auto-focusing control.

Correction for noise in the above-mentioned motor controlling technology is an essential technological factor in performing precision controlling. Particularly, in fields in which precision controlling is required, noise may be generated in an element such as a resistor, or the like, due to errors in a temperature or a process and such noise may cause errors in driving a motor.

Motor controlling technology according to the related art has been used to perform a feedback controlling of motors using a sensing resistor connected to an output terminal. In this case, since a resistance value is determined depending on an amplitude of a current applied to the output terminal, a resistor having a relatively low resistance value is used as the sensing resistor in most cases. The above-mentioned sensing resistor having the relatively low resistance value may cause a large amount of errors, due to errors in the temperature or the process.

The related art associated with the inventions described above may be understood with reference to Korean Patent Laid-Open Publication No. 2006-0007930 and Japanese Patent Laid-Open Publication No. 2001-273735.

### RELATED ART DOCUMENT

(Patent Document 1) Korean Patent Laid-Open Publication No. 2006-0007930

(Patent Document 2) Japanese Patent Laid-Open Publication No. 2001-273735

### SUMMARY

An exemplary embodiment in the present disclosure may provide a motor driving apparatus and a motor system capable of stably driving a motor even in the case in which a change in an external environment such as a change in temperature, or the like, occurs, and a correction circuit thereof.

According to an exemplary embodiment in the present disclosure, a motor driving apparatus may include: a controlling unit outputting a digital code; a converting unit converting the digital code into an analog driving signal; and a correction unit changing the analog driving signal at a predetermined ratio using a plurality of resistors.

According to an exemplary embodiment in the present disclosure, a motor system may include: a motor apparatus; and a motor driving apparatus driving the motor apparatus by compensating for a change in temperature using a current output digital-analog conversion.

According to another exemplary embodiment in the present disclosure, a correction circuit correcting an output of a current output digital-analog converter may include: a correction circuit unit changing an analog driving signal output from the current output digital-analog converter at a predetermined ratio using a plurality of resistors; and a mirror circuit unit amplifying the analog driving signal output from the correction circuit unit.

### BRIEF DESCRIPTION OF THE DRAWINGS

The above and other aspects, features and other advantages in the present disclosure will be more clearly understood from the following detailed description taken in conjunction with the accompanying drawings, in which:

FIG. 1 is a configuration diagram illustrating an example of a motor driving apparatus according to an exemplary embodiment in the present disclosure;

FIG. 2 is a configuration diagram illustrating another example of the motor driving apparatus according to an exemplary embodiment in the present disclosure;

FIG. 3 is a configuration diagram illustrating an example of a converting unit;

FIG. 4 is a configuration diagram illustrating another example of the converting unit; and

FIG. 5 is a circuit diagram illustrating an example of a correction circuit according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

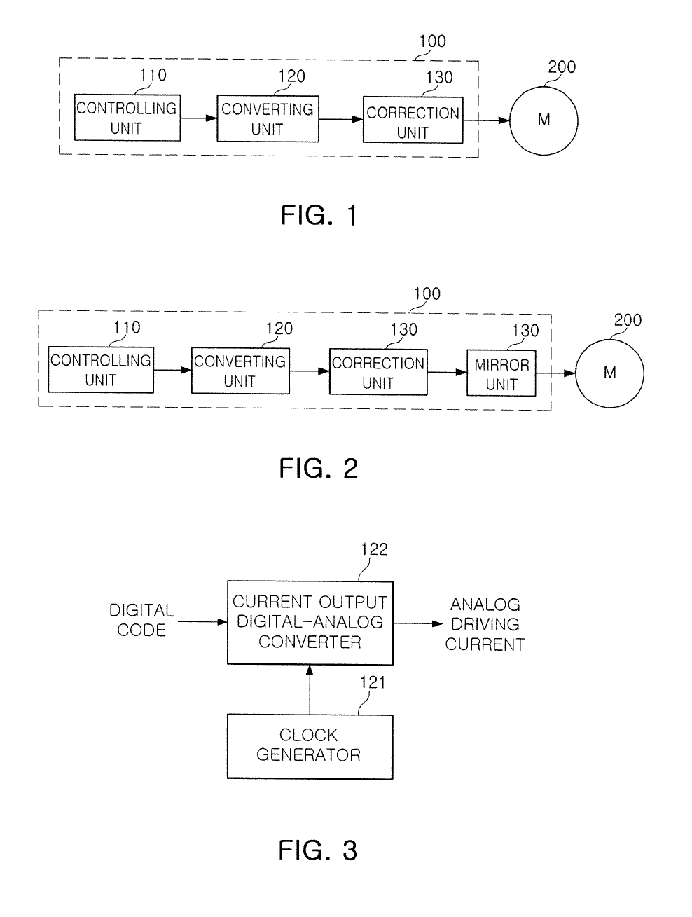

FIG. 1 is a configuration diagram illustrating an example of a motor driving apparatus according to an exemplary embodiment in the present disclosure.

Referring to FIG. 1, a motor driving apparatus 100 may provide an analog driving signal to a motor apparatus 200. In an example, the motor driving apparatus 100 may drive the motor apparatus 200 by compensating for a change in temperature using a current output digital-analog conversion.

The motor driving apparatus 100 may include a controlling unit 110, a converting unit 120, and a correction unit 130.

The controlling unit 110 may output a digital code. The digital code, which is a predetermined digital value, may be determined as the number of preset bits depending on examples.

In an example, the controlling unit 110 may determine the digital code so as to receive a target value from the outside and move the motor apparatus 200 to a position corresponding to the target value.

For example, the controlling unit 110 may maintain a first coordinate for a current position of the motor apparatus 200 and may determine a movement distance corresponding to a difference of a second coordinate for a target position received from the outside and the first coordinate. The controlling unit 110 may output the digital code corresponding to the determined movement distance.

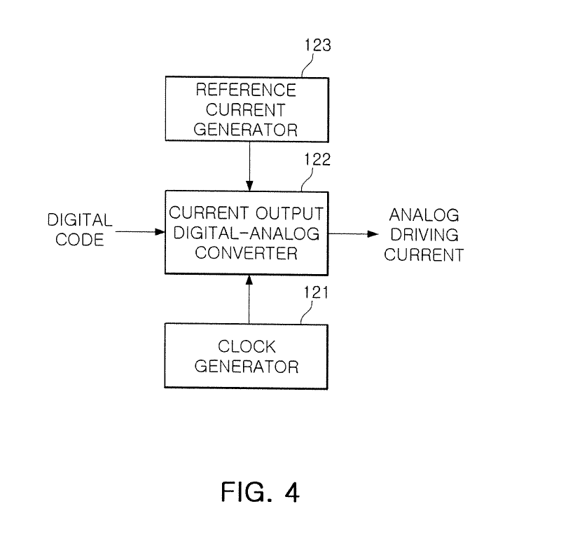

The converting unit 120 may convert the digital code into an analog driving signal. Various examples of the converting unit 120 will be described below in more detail with reference to FIGS. 3 and 4.

The correction unit 130 may change the analog driving signal output from the converting unit 120 at a predetermined ratio using a plurality of resistors.

In an example, the correction unit 130 may include first and second resistors and may decrease the analog driving signal at a resistance ratio of the second resistor to the first resistor. Since the correction unit 130 may change the analog driving signal using the ratio between the resistors, it may significantly decrease an influence due to the change in temperature or an error in a process. That is, since the related art uses a single resistor, an error due to the influence of the temperature or the error in the process may occur. However, in the present example, even in the case in which the influence of the temperature has effect on the plurality of resistors, since a resistance ratio between the plurality of resistors is used, the influence of the temperature may be offset. The similar effect may also be present in the error in the process.

FIG. 2 is a configuration diagram illustrating another example of the motor driving apparatus according to an exemplary embodiment in the present disclosure. An example illustrated in FIG. 2 may further include a mirror unit 140 in addition to the components in an example illustrated in FIG. 1.

Referring to FIG. 2, the mirror unit 140 may amplify the analog driving signal output from the correction unit 130. Since the correction unit 130 changes the analog driving signal as the ratio between the resistors to compensate for the error such as the temperature, or the like, the mirror unit 140 may amplify the analog driving signal to be required to drive the motor apparatus 200.

The mirror unit 140 may be implemented using various mirror circuits according to examples.

FIG. 3 is a configuration diagram illustrating an example of a converting unit.

Referring to FIG. 3, the converting unit 120 may include a clock generator 121 and a current output digital-analog converter 122.

The clock generator 121 may generate a predetermined unit clock and provide it to the current output digital-analog converter 122. Since the unit clock may be used as a time reference which converts a digital value into an analog value, the clock generator 121 may variably adjust a frequency of the unit clock according to the examples.

The current output digital-analog converter 122 may output an analog driving current corresponding to the received digital code. In the case in which the current output digital-analog converter 122 is used, the above-mentioned analog driving signal may become a current signal, that is, the analog driving current.

FIG. 4 is a configuration diagram illustrating another example of the converting unit.

An example of the converting unit illustrated in FIG. 4 may further include a reference current generator 123 in addition to the components in an example of the converting unit illustrated in FIG. 3.

The reference current generator 123 may generate a reference current using a reference voltage. The current output digital-analog converter 122 may output an analog driving current using the reference current provided from the reference current generator 123.

In an example, the reference voltage may have a source different from a voltage used for the motor driving apparatus 100. The reference voltage may be supplied from a stable source. In this case, the reference current generated from the reference voltage may have stable characteristics for the temperature, or the like.

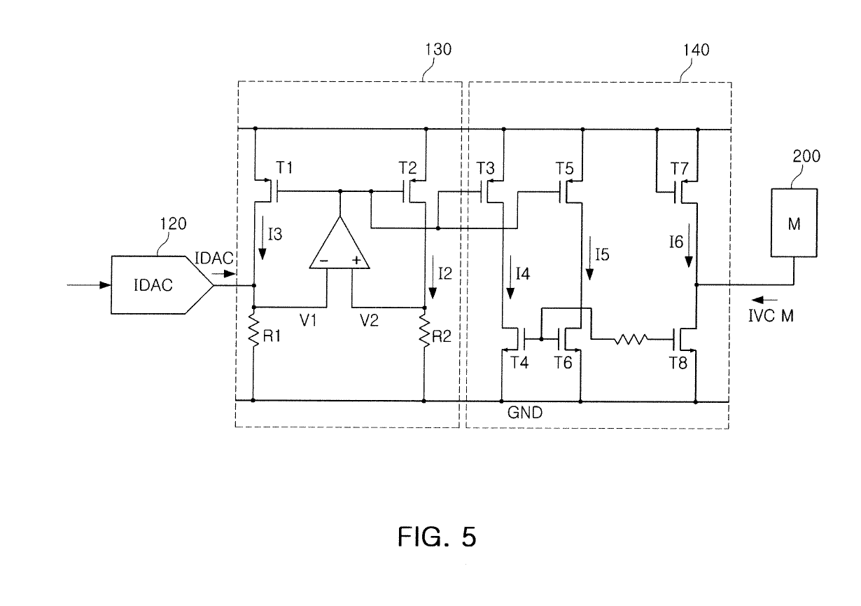

FIG. 5 is a circuit diagram illustrating an example of a correction circuit according to an exemplary embodiment in the present disclosure.

Referring to FIG. 5, the correction circuit may correct an output of the current output digital-analog converter 122. The correction circuit may include a correction circuit unit 130 and a mirror circuit unit 140. Here, the correction circuit unit 130 and the mirror circuit unit 140 may correspond to the correction unit 130 and the mirror unit 140, respectively, described above with reference to FIGS. 1 through 4.

The correction circuit unit 130 may change the analog driving signal output from the current output digital-analog converter 122 at a predetermined ratio using a plurality of resistors.

In an example, the correction circuit unit 130 may include a first resistor R1 connected to an output terminal of the converting circuit 120, a second resistor R2 connected to an output terminal of the correction circuit 130, and an amplifier connected to the first resistor and the second resistor, respectively.

In an example, the correction circuit unit 130

may decrease the analog driving signal at a resistance ratio of the second resistor to the first resistor.

The mirror circuit unit 140 may amplify the analog driving signal output from the correction circuit.

Currents and voltages illustrated in FIG. 5 may be expressed by the following Equations.

$$\begin{matrix} {V}_{1} = {R}_{1} * ( {I}_{DAC} + {I}_{3} ) & [ Equation 1 ] \\ {I}_{2} = \frac{{V}_{2} ( \approx {V}_{1} )}{{R}_{2}} = \frac{{R}_{1}}{{R}_{2}} * ( {I}_{DAC} + {I}_{3} ) & [ Equation 2 ] \\ {I}_{3} = \frac{{R}_{1}}{{R}_{2}} * {I}_{DAC} + {( \frac{{R}_{1}}{{R}_{2}} )}^{2} * {I}_{DAC} + {( \frac{{R}_{1}}{{R}_{2}} )}^{3} * {I}_{DAC} … {( \frac{{R}_{1}}{{R}_{2}} )}^{n} & [ Equation 3 ]\end{matrix}$$

where since R₁<<R₂ and

$${( \frac{{R}_{1}}{{R}_{2}} )}^{n}$$

has a very small value at n which is equal or more (n>=3),

$${( \frac{{R}_{1}}{{R}_{2}} )}^{n}$$

may be ignored.

Since T2, T3, and T5 form a current mirror, all of them have the same channel width. Therefore, a relationship of I₂, I₄, and I₅ may be expressed by the following Equation 4.

I₂=I₄=I₅ [Equation 4]

In addition, since T4, T6, and T8 form a current mirror, all of them have different channel widths. Therefore, a relationship of I_{VCM} and I₄, or and I_{VCM} and I₅ may be expressed by the following Equation 5.

$$\begin{matrix}IVCM = ( \frac{T 9 of Channel Width}{T 4 of Channel Width} ) \times I 4 \\ = ( \frac{T 9 of Channel Width}{T 4 of Channel Width} ) \times I 2 \\ = ( \frac{T 9 of Channel Width}{T 4 of Channel Width} ) \times ( \frac{R 1}{R 2} ) \times \\ ( 1 + \frac{R 1}{R 2} + \frac{R {1}^{2}}{R 2} ) I DAC\end{matrix} \qquad [ Equation 5 ]$$

where I₆ is a very small current (several nano-Ampere), which may be ignored.

Here, in the case that I_{DAC} is 100 μA, R₁ is 3.6 kΩ, R₂ is 12.5 kΩ, and I_{VCM} is 19.3 mA, a driving ratio A of a total current may correspond to 194. This may be expressed by the following Equation 6.

$$\begin{matrix}A = \frac{50 um * 8 * 60}{50 um * 1 * 1} * \frac{3.6 kohm}{12.5 kohm} ( \begin{matrix}1 + \frac{3.6 kohm}{12.5 kohm} + \\ \frac{3.6 {kohm}^{2}}{12.5 kohm} ⋯\end{matrix} ) \\ = 480 * 0.288 * ( 1 + 0.40 ) \\ = 480 * 0.404 \\ = 194\end{matrix} \qquad [ Equation 6 ]$$

That is, in the case that a width ratio of mirror transistors of the mirror circuit unit 140 is 1:1, I₂ is equal to I₄ by the mirror circuit. In addition, in the case that the width ratio of the mirror transistor and the last transistor T8 in the mirror circuit unit 140 is 1:480, a ratio of the output current I₂ of the mirror circuit unit 140 to a last driving current I_{VCM} may become 480 times. Here, in the case that a ratio of the resistor R₂ to the resistor R₁ is 0.45, a ratio of an output current of the converting unit 120 to a last driving current may become 194 times.

In an example, the ratio of the resistor R₂ to the resistor R₁ may be 1 or less. That is, the ratio of the resistor R₂ to the resistor R₁ may be determined so that a maximum output of the mirror circuit unit 140 for a maximum output current of the converting unit 120 may be obtained. For example, it may be appreciated that in the case that a maximum I_{VCM} is 120 mA, the maximum current of the converting unit 120 is 550 μA, the width of the transistor T1 is 1 μm, and the width of the transistor T8 is 480 μm, and Equation 6 is substituted, a value of R₁/R₂ is 0.45. Here, in order to have linearity, R₁ may be determined so that an input voltage V₁ of the transistor T1 becomes 1.6V.

As set forth above, according to exemplary embodiments in the present disclosure, even in the case in which the external environment change such as the temperature change, or the like occurs, the motor may be stably driven.

While exemplary embodiments have been shown and described above, it will be apparent to those skilled in the art that modifications and variations could be made without departing from the scope of the invention as defined by the appended claims.

What is claimed is:

1. A motor driving apparatus comprising:
a controlling unit outputting a digital code;
a converting unit converting the digital code into an analog driving signal; and
a correction unit changing the analog driving signal at a predetermined ratio using a plurality of resistors.

2. The motor driving apparatus of claim 1, wherein the converting unit includes a current output digital-analog converter outputting an analog driving current corresponding to the digital code as the analog driving signal.

3. The motor driving apparatus of claim 2, wherein the converting unit further includes a reference current generator generating a reference current using a reference voltage and the reference current has an amplitude independent of a change in temperature.

4. The motor driving apparatus of claim 1, wherein the correction unit decreases the analog driving signal at a resistance ratio of a second resistor to a first resistor.

5. The motor driving apparatus of claim 1, wherein the correction unit includes:
a first resistor connected to an output terminal of the converting unit;
a second resistor connected to an output terminal of the correction unit; and
an amplifier connected to the first resistor and the second resistor, respectively.

6. The motor driving apparatus of claim 1, wherein the controlling unit determines the digital code so as to move a motor to a position corresponding to a target value input from the outside.

7. The motor driving apparatus of claim 1, further comprising a mirror unit amplifying the analog driving signal output from the correction unit.

8. A motor system comprising:
a motor apparatus; and
a motor driving apparatus driving the motor apparatus by compensating for a change in temperature using a current output digital-analog conversion.

9. The motor system of claim 8, wherein the motor driving apparatus includes:
a controlling unit outputting a digital code;
a converting unit converting the digital code into an analog driving signal; and
a correction unit changing the analog driving signal at a predetermined ratio using a plurality of resistors.

10. The motor system of claim 9, wherein the converting unit includes a current output digital-analog converter outputting an analog driving current corresponding to the digital code as the analog driving signal.

11. The motor system of claim 10, wherein the converting unit further includes a reference current generator generating a reference current using a reference voltage and the reference current has an amplitude independent of the change in temperature.

12. The motor system of claim 9, wherein the correction unit decreases the analog driving signal at a resistance ratio of a second resistor to a first resistor.

13. The motor system of claim 9, wherein the correction unit includes:
a first resistor connected to an output terminal of the converting unit;
a second resistor connected to an output terminal of the correction unit; and
an amplifier connected to the first resistor and the second resistor, respectively.

14. A correction circuit corrrecting an output of a current output digital-analog converter, the correction circuit comprising:
a correction circuit unit changing an analog driving signal output from the current output digital-analog converter at a predetermined ratio using a plurality of resistors; and
a mirror circuit unit amplifying the analog driving signal output from the correction circuit unit.

15. The correction circuit of claim 14, wherein the correction circuit unit decreases the analog driving signal at a resistance ratio of a second resistor to a first resistor.

16. The correction circuit of claim 14, wherein the correction circuit unit includes:
a first resistor connected to an output terminal of the converting circuit;
a second resistor connected to an output terminal of the correction circuit unit; and
an amplifier connected to the first resistor and the second resistor, respectively.
